(19) United States
(12) Patent Application Publication
(10) Pub. No.: US 2004/0250910 A1
(43) Pub. Date: Dec. 16, 2004

(54) Method and apparatus for separating loosened bark and logs

(76) Inventors: Antti Tohkala, Pori (FI); Pekka Jaakohuhta, Noormarkku (FI); Pauli Vienola, Pori (FI); Arvo Jonkka, Pori (FI)

Correspondence Address: BURNS DOANE SWECKER & MATHIS L L P, POST OFFICE BOX 1404, ALEXANDRIA, VA, 22313-1404, US

(21) Appl. No.: 10/485,867

(22) PCT Filed: Aug. 19, 2002
(86) PCT No.: PCT/FI02/00676

(30) Foreign Application Priority Data
Aug. 20, 2001 (FI) 20011670

(51) Int. Cl. B27L 1/00; B27L 3/00

(52) U.S. Cl. 144/340; 144/208.1; 144/208.9

(57) ABSTRACT

The present invention relates to method for separating loose bark from a flow of debarked wood logs are conveyed substantially in the direction of their longitudinal axis along a substantially horizontal conveyor track. During their travel, the logs are forced into unidirectional accelerating rotation that simultaneously moves the logs laterally. An accelerating rotary motion is advantageously imparted to the logs on a rolling ramp adapted between two conveyors operating at different height levels.

The present invention relates to a method and apparatus for separating loose bark from a flow of wood logs and bark. The invention also relates to an apparatus for implementing the method.

In the paper and pulp industry, logs are debarked prior to chipping and subsequent process steps of fiber products. Depending on the quality requirements of the cellulosic pulp or paper grade being manufactured, more or less complete debarking of the wood logs is necessary. Conventionally, debarking is made in a purpose-designed debarking drum. Debarking drums are provided with bark slots via which most of the bark pieces torn off from the logs are removed from the flow of logs. In certain type of wood used as raw material, the bark is tightly bonded to the body of the log, whereby the bark dislodges at a late stage of debarking or, alternatively, the bark is dislodged from the trunk readily but in rather large pieces or long strings that cannot leave the debarker via the bark slots but instead, exit with the logs from the discharge end of the debarking drum. In particular, certain tropical wood species such as acacia and some eucalyptus species are problematic in drum debarking inasmuch the long bark strings that are characteristic of these species tend to avoid the bark slots of the drum thus traveling along with the log flow to the infeed conveyor of the chipper.

Generally, the chipper infeed conveyor includes a roller track intended to perform separation of the remainder of dislodged bark pieces from the log flow. However, long bark strings dislodged from the logs have proven difficult to separate from the log flow on the roller track This is because the bark strings are either wrapped about the logs or travel the entire length of the roller track as a blanket atop the logs, whereby the bark strings cannot fall through the slots provided between the rollers. In the debarking drum, discrete pieces of bark may also form bark balls occasionally containing pieces of short wood and slivers dislodged from the log body. This kind of bark balls travel over the rollers in blankets so large and solid that the individual pieces of bark cannot fall via the slots between the rollers. Particularly, if the bark blanket happens to land on logs traveling on the roll track of the chipper infeed line, the chances of separating the bark blankets from the log flow on conventional roller tracks are marginal. Furthermore, the slots between the rollers cannot be widened excessively without a concomitant increase in wood loss.

Roll conveyor tracks have been especially developed for removing long strings of bark. For instance in patent publication WO9938662 is disclosed an assembly having the successive rollers of the conveyor placed at different heights thus forming in the roll track a recess, wherein the bark pieces or balls should fall. In front of the breakage-trap recess is placed a roller with projections that imposes strong knocks on the logs. Obviously, the method is an effective way of enhancing removal of bark from logs. However, modern high-volume process lines move on the roll track a plurality of logs side by side or even in multiply layered, whereby the logs form a tight platform for the bark traveling thereon. Hence, knocking alone is not a sufficient technique for dropping bark away from the top of the solid bunch of logs.

The method according to the present invention makes it possible to separate the bark on the chipper infeed line in an improved fashion from the log bodies of the wood infeed flow. In the method, logs are forced during their travel into unidirectional rotation that takes place about the longitudinal axis of the log and simultaneously moves the logs laterally. The method is characterized in that it sets the logs in an accelerating rotary motion that rapidly changes the mutual lateral distances between the logs traveling on the roller track, whereby the bark resting atop the logs is given a chance to fall off from above the logs and further down via the slots provided between the rollers.

An apparatus according to the invention comprises a first roller conveyor and a second roller conveyor for transporting the debarked logs substantially longitudinally, and such an apparatus is characterized in that the first and the second roller conveyor are located to operate in parallel with each other for a conveyor length not shorter than the maximum length of the logs being handled and that the first roller conveyor includes means that are capable of accomplishing the lateral transfer of the logs toward the second roller conveyor at the parallel portion of the adjacent conveyors and that the first roller conveyor is connected at the parallel portion of the adjacent conveyors to the second roller conveyor in order to accomplish the accelerating rotary motion of the logs about their longitudinal axis.

Next, the invention will be examined in greater detail by making reference to the attached drawings wherein

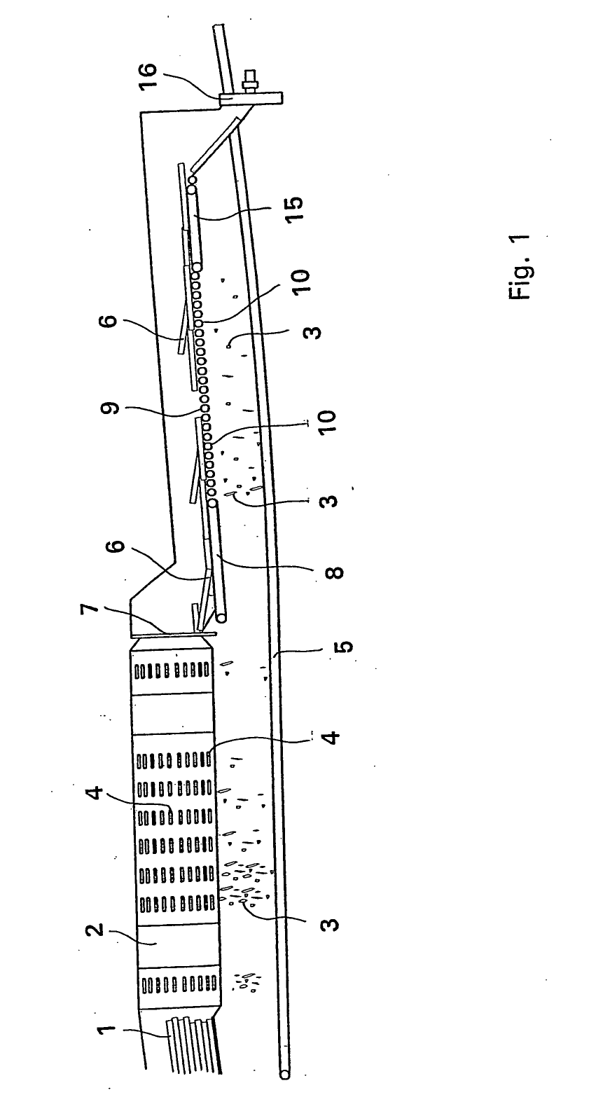

FIG. 1 shows a debarking line of subtropical deciduous wood logs at a section of the line located between the debarking drum and the chipper;

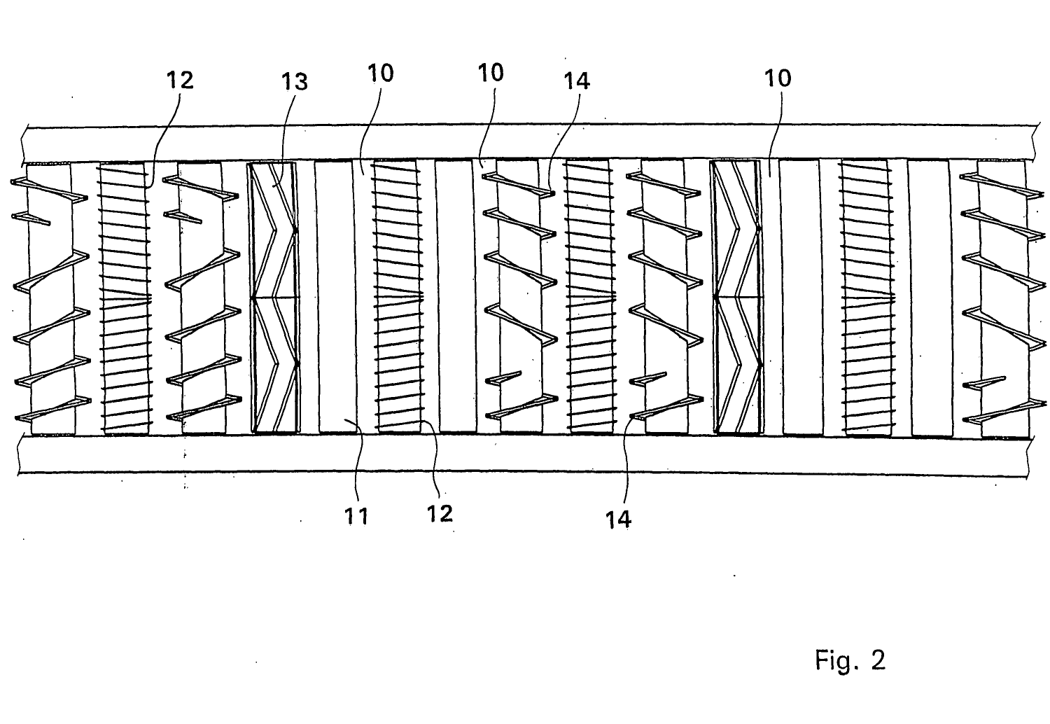

FIG. 2 shows a portion of a conventional roller conveyor;

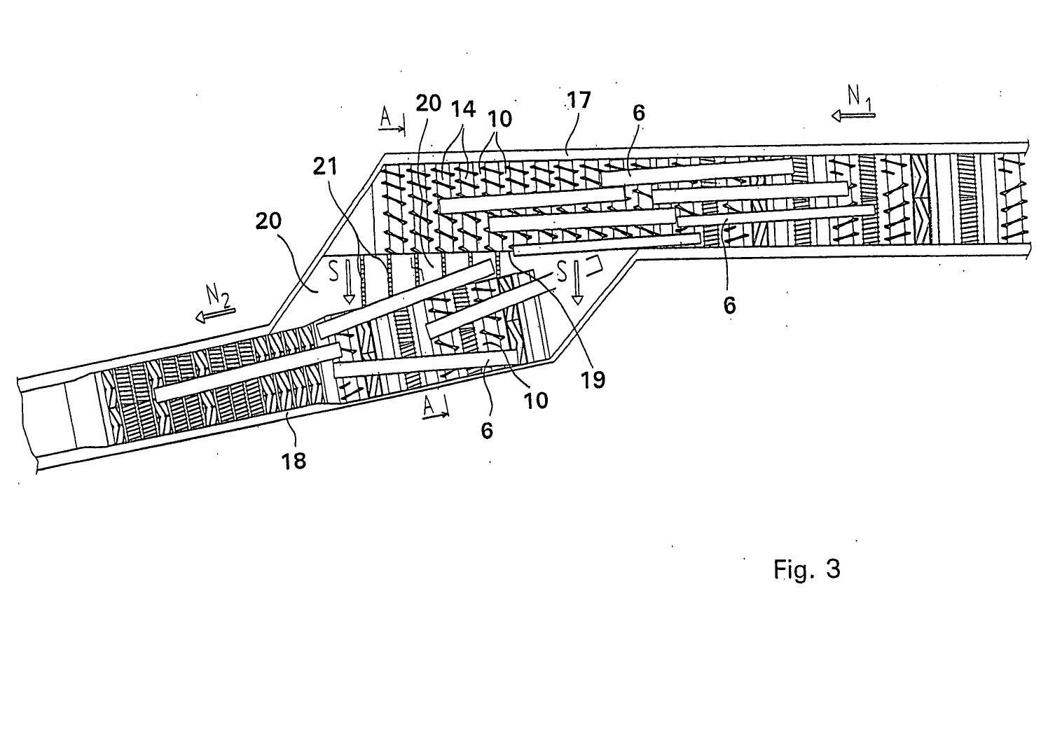

FIG. 3 shows a roller conveyor assembly according to the invention; and

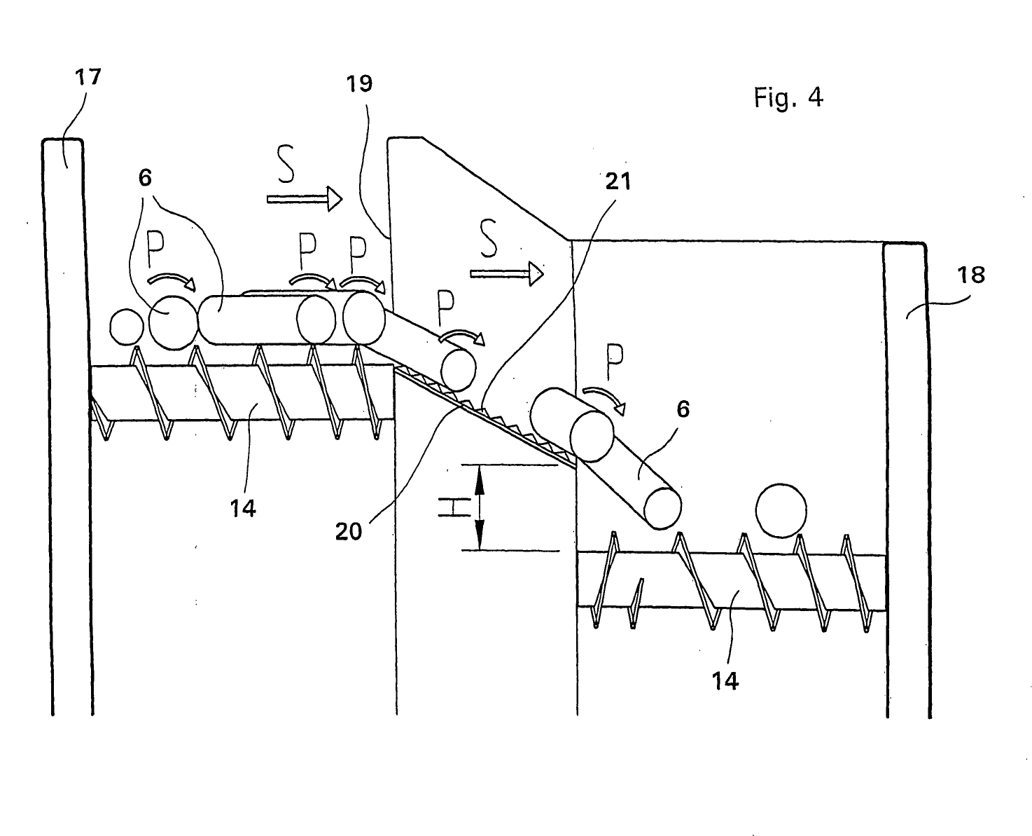

FIG. 4 shows a sectional view of FIG. 3 taken along line A-A.

In FIG. 1 is illustrated an exemplary embodiment of a conventional chipper infeed line in a debarking section of a mill operated in a subtropical environment, wherein the wood material is never frozen at any time of the year. Logs 1 trimmed to given log lengths are debarked in a continuously operating rotary debarking drum 2, wherein the mutual attrition of logs dislodges bark 3 from the log bodies and makes a major portion of the bark to fall via bark slots 4 onto a bark removal conveyor 5. The debarked logs 6 travel past a drum gate 7 to a drum discharge conveyor 8, whereon depending on the species of wood being debarked also a portion of the bark lands. Downstream of the drum discharge conveyor 8 is located a roller assembly 9 intended to perform separation of the remainder of the bark entrained in the log flow. On the roller assembly 9, bark 3 falls onto the bark discharge conveyor 5 via slots 10 provided between the rollers. To improve the separation of bark, the roller assembly may contain different kinds of rollers and roller sets as shown in FIG. 2. For this purpose, it is possible to use among other means such members as smooth rollers 11 and different kinds of projections such as spikes 12, ribs 13 or auger-flight rollers 14 having spiraled ribs.

If the wood species happens to be such that its bark dislodges as long strings or the bark is otherwise difficult to handle, a significant portion of the bark may be carried over with the log flow across the length of the roller assembly 9 to the chipper infeed conveyor 15. This is because elongated strings of bark do not readily fall down via the slots 10 provided between the rollers. Then, the chipper infeed conveyor 15 transports the debarked logs 6 and the possible residues of bark resting thereon further to the chipper 16. Thence, effective removal of bark from the log flow cannot be implemented by conventional techniques but rather, bark is carried over with the chips to the successive process steps causing a plurality of different problems therein.

The method according to the present invention is elucidated in FIGS. 3 and 4. As shown therein, the roller assembly is divided into two roller conveyor sections 17 and 18 that are adapted to operate for a given length in parallel with each other. The roller conveyors transport the logs in the direction designated in the diagrams by arrows N₁ and N₂. The exit-end rollers of the first conveyor 17 are located at a higher level than the ingoing-end rollers of the second conveyor 18. In the embodiment discussed herein, some or all of the exit-end rollers of the first conveyor 17 are auger-flight rollers 14. The function of the auger flights is to rotate the logs 6 in the direction designated by arrows P and to drive the logs laterally as designated by arrow S to that side 19 of the first roller conveyor 17 which is adjacent to the second roller conveyor 18. Thus, the logs can fall along a rolling ramp 20 from the exit end of the first conveyor 17 onto the next conveyor 18. Due to the lateral movement (arrow S) and rotation (arrow P) of the logs about their longitudinal axis at the exit end of the first conveyor 17 on the rolling ramp 20 between the conveyors and at the ingoing end of the second conveyor 18, the layered flow of multiple logs is scattered open, whereby bark possibly accumulated on the logs can fall onto the conveyor and further down onto the bark discharge conveyor via the slots 10 provided between the rollers.

The rotary movement of the logs on the rolling ramp 20 between the adjacent conveyors may be enhanced by means of toothed rails 21 mounted on the ramp. The function of rails 21 is to increase the friction between the logs and the ramp as the logs roll gravitationally along the ramp.

The height difference between the lower edge of the rolling ramp 20 and the ingoing end of the second conveyor is designated by dimension H. The dimension H may be set zero or larger. Advantageously, dimension H is set sufficiently large as illustrated in FIG. 4, whereby the dropping of logs also enhances the dislodging of bark.

The second conveyor 18 may be aligned parallel with or slightly angled in regard to the longitudinal direction of the first conveyor 17. However, it is an essential feature of the invention that the two conveyors run substantially in parallel for a given portion of their overall length as seen from above of the conveyors.

Without departing from the scope of the invention, the accelerating rotary motion of logs during their transition travel between conveyors 17 and 18 can be implemented differently from that described in the above exemplifying embodiment. To accomplish this function, any kind of conventional conveyor construction may be used that is capable of transferring logs laterally with simultaneously imparting them into a rotary motion. As such devices can be used, e.g., the above-described auger-flight rollers by way of arranging the auger flight pitch to become coarser in the travel direction of the logs.

Furthermore, the transfer of the logs from the first roller conveyor 17 to the second roller conveyor 18 may be controlled by suitably mounted guiding gage or such a guiding gage can be used to augment the log transfer motion imparted by the auger-flight rollers.

1. A method for separating loose bark from a flow of debarked wood logs wherein the logs are conveyed substantially in the direction of their longitudinal axis along a substantially horizontal conveyor track and the logs are forced during their travel into unidirectional rotation that simultaneously moves the logs laterally, wherein at least for a given time the rotary motion takes place in an accelerating fashion.

2. The method of claim wherein at least a portion of the accelerating rotary motion of the logs is accomplished by setting the logs into a gravitational falling motion along a rolling ramp.

3. The method of claim 2, wherein the falling motion is arranged to deviate the travel direction of the logs.

4. An apparatus for separating loose bark from logs, whereby the apparatus comprises a first roller conveyor (17) and a second roller conveyor (18) for moving the debarked logs substantially longitudinally, wherein the first roller conveyor (17) and the second roller conveyor (18) are located to operate in parallel with each other for a conveyor length not shorter than the maximum length of the logs being handled, that the first roller conveyor (17) includes means (14) capable of accomplishing the lateral transfer of the logs toward the second roller conveyor (18) at the parallel portion of the adjacent conveyors, and that the first roller conveyor (17) is connected at the parallel portion of the adjacent conveyors to the second roller conveyor (18) in order to accomplish an accelerating rotary motion of the logs about their longitudinal axis.

5. The apparatus of claim 4, wherein the second roller conveyor (18) is at least at the parallel portion of the adjacent conveyors located at a lower level than the first roller conveyor (17).

6. The apparatus of claim 4, wherein the first roller conveyor (17) and the second roller conveyor (18) at the parallel portion of the adjacent conveyors are connected to each other by means of a rolling ramp.
